(19) United States
(12) Patent Application Publication
(10) Pub. No.: US 2006/0045242 A1
(43) Pub. Date: Mar. 2, 2006

(54) Deployment of announcements in local exchange switching platform

(75) Inventor: James Cole Isaacson, Antioch, CA (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Austin, TX (US)

(21) Appl. No.: 10/930,782

(22) Filed: Sep. 1, 2004

(51) Int. Cl. H04M 1/64

(52) U.S. Cl. 379/88.17

(57) ABSTRACT

A custom announcement is efficiently deployed to a local exchange switching platform, such as a switch from the Nortel DMS family. Initially, an announcement provider creates a binary file representing the requested announcement and stores the file on a server accessible to a telecommunications carrier. A representative of the telecommunications carrier then downloads the file from the server. Subsequently, a specific record length is set to override a default record length in a program that communicates with the local exchange switching platform. The program then electronically transfers the binary announcement file to the local exchange switching platform using the specific record length.

### BACKGROUND OF THE INVENTION

1. Field of the Invention

The present invention relates to the field of telecommunications. More particularly, the present invention relates to efficiently deploying announcements to local exchange switching platforms.

2. Background Information

Local exchange switching platforms (also referred to as switches) store and play custom announcements that are specific to a telecommunications carrier. Typically, files storing the announcements are binary files. Because some types of switches are based upon old IBM mainframe platforms, these switches require the record length to be specified for every binary file being received.

The prior art process for deploying new messages to these switches was cumbersome. The switch vendor was required to create an announcement that was stored on tapes in a binary file format. A tape was sent to each switch that required the new announcement. A technician then located the tape and directly copied the binary file (i.e., announcement) to the disk of the switch. After each switch had the new announcement loaded, the carrier could then begin to use the new announcement. This deployment process typically took months to complete, including about three man-hours for each switch.

If a switch lost the announcement, for example due to a power failure or disk failure, a technician would have to be dispatched to the remote location of the switch. The technician would then have to locate the tape and reload the binary file onto the disk. The process incurred additional costs for dispatching the technician and locating the tape.

Current programs for remotely communicating with these types of switches can apply software updates to the switches. However, these updates require a 128 byte record length, as do the programs that communicate with the switches. Thus, announcement files, which have a record length of 44 bytes cannot be sent to the switches with present day programs. Moreover, because up until now tapes have been used to store the announcement files, and the tapes had to be physically loaded into each switch, the possibility of modifying and using such a remote communications program did not exist.

A process for more efficiently deploying customized announcements to switches is therefore needed.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a system diagram, according to an aspect of the present invention;

FIG. 2 illustrates a flow diagram for a master program, in accordance with an aspect of the present invention; and

FIG. 3 illustrates a flow diagram for a secondary program, in accordance with an aspect of the present invention.

### DETAILED DESCRIPTION

An object of the present invention is to efficiently deploy announcements to local exchange switching platforms, such as switches from the Nortel DMS family available from Nortel Networks Limited. Exemplary switches include the DMS-100, DMS-200, DMS-250, DMS-500, etc.

According to the present invention, an announcement file is created by the switch vendor and stored on a server. Once the announcement is ready for deployment, a user launches an application that downloads the announcement from the server and then downloads the announcement to the switch. Thus, the need for tapes, and the need for a technician are eliminated. Consequently, a new announcement can be deployed in only a day or two. Moreover, the present invention reduces costs associated with deploying an announcement, especially in states that do not tax software received electronically.

In view of the above, the present invention through one or more of its various aspects and/or embodiments is presented to accomplish one or more objectives and advantages, such as those noted below.

According to an aspect of the present invention, a method is provided for deploying a custom announcement to a local exchange switching platform of a telecommunications carrier. The method includes storing on a server a binary file comprising the custom announcement; and electronically providing the binary file to the telecommunications carrier. The method further includes enabling the telecommunications carrier to electronically transfer the binary file to the local exchange switching platform. The local exchange switching platform may be a Nortel DMS switch.

According to another aspect of the present invention, a method is provided for deploying a custom announcement to a local exchange switching platform of a telecommunications carrier. The method includes electronically receiving, from a server, a binary file comprising the custom announcement, and overriding a default record length with a specific record length. The binary file is electronically transferred, using the specific record length, to the local exchange switching platform.

The local exchange switching platform may be a Nortel DMS switch. In this case, the method may also include determining a protocol of the DMS switch prior to electronically transferring the binary file, using the specific record length, to the DMS switch. When the protocol is DMSCOM, the electronically transferring the binary file includes transferring directly to the DMS switch using the DMSCOM protocol. When the protocol is IP, the electronically transferring the binary file includes transferring to the DMS switch via a supernode data manager (SDM) using file transfer protocol (FTP). The method may also include generating a list of DMS switches in a region; and electronically transferring the binary file, using the specific record length, to each DMS switch in the generated list.

In another aspect, a computer readable medium stores a program for deploying a custom announcement to a local exchange switching platform. The program includes a master code segment and a secondary code segment. The master code segment electronically receives a binary announcement file stored on a server and sets a record length. The secondary code segment receives the set record length and electronically transfers the binary announcement file, using the set record length, to the local exchange switching platform.

The local exchange switching platform may be a Nortel DMS switch. In one embodiment, the secondary code segment determines a protocol of the DMS switch prior to electronically transferring the binary file using the specific record length. When the protocol is DMSCOM, the secondary program electronically transfers the binary file, using the specific record length, directly to the DMS switch using the DMSCOM protocol. When the protocol is IP, the secondary program electronically transfers the binary file, using the specific record length, to the DMS switch via a supernode data manager (SDM) using file transfer protocol (FTP). In this case, the secondary program communicates the specific record length to a program residing on the SDM, and the SDM program communicates the specific record length to a program residing on the DMS switch.

The master program may generate a list of DMS switches within a region; and electronically transfer the binary file, using the specific record length, to each DMS switch in the generated list. In response to receiving a user-indicated filename of the binary announcement file, the master program electronically receives the binary announcement file from the server of an announcement provider. In one embodiment, the master program passes parameters to the secondary program, including a filename of the binary announcement file, a name of the DMS switch to receive the binary announcement file, and the specific record length.

In yet another aspect of the present invention, a system is provided for deploying a custom announcement to a local exchange switching platform of a telecommunications carrier. The system includes multiple local exchange switching platforms, and a first server. The first server resides in a region of the telecommunications carrier and electronically receives a binary announcement file from a second server. The first server also electronically transfers the binary announcement file to at least one of the local exchange switching platforms using a specific record length that overrides a default record length.

The local exchange switching platforms can be Nortel DMS switches. The first server can run customer services computer access network standard (CSCANS) software. In one embodiment, at least one of the DMS switches includes a supernode data manager (SDM) and an Internet protocol (IP) DMS switch. When the first server determines a protocol of the DMS, switch prior to electronically transferring the binary file using the specific record length, and the protocol is DMSCOM, the first server electronically transfers the binary file directly to the DMS switch using the DMSCOM protocol. When the protocol is IP, the first server electronically transfers the binary file to the IP DMS switch via the SDM using file transfer protocol (FTP). In this case, the first server communicates the specific record length to a program residing on the SDM, and the SDM then communicates the specific record length to a program residing on the DMS switch.

In one embodiment, the first server generates a list of DMS switches within the region, and electronically transfers the binary file, using the specific record length, to each DMS switch in the generated list. In another embodiment, the first server electronically receives the binary announcement file from the server of an announcement provider in response to receiving a user-indicated filename of the binary announcement file.

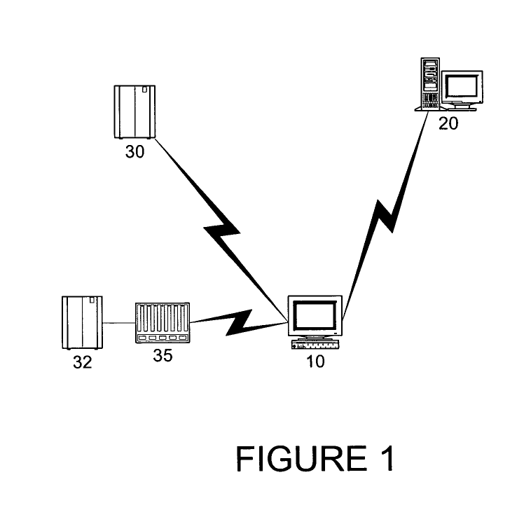

Referring to FIG. 1, a system in which the present invention operates is now described. A computer system 10, running software such as a customer services computer access network standard (CSCANS) is operated by the telecommunications carrier. CSCANS is available from national electronic system assistance center (NESAC). In one embodiment, a different CSCANS 10 is located in each region serviced by the telecommunications carrier. Another computer system 20, such as a customer access node (CAN) is operated by the announcement provider, who is typically the switch vendor. The CSCANS 10 communicates with the CAN 20 across any type of network connection. Switches 30, 32, such as the Nortel DMS-100, also communicate with the CSCANS 10 via a network connection. Switch 30 operates with a proprietary protocol for interfacing (such as DMSCOM), whereas switch 32 operates via Internet protocol (IP) and employs an supernode data manager (SDM) 35 as an intermediary for all communications. The SDM 35 permits the use of file transfer protocol (FTP) for communicating to the switch 32.

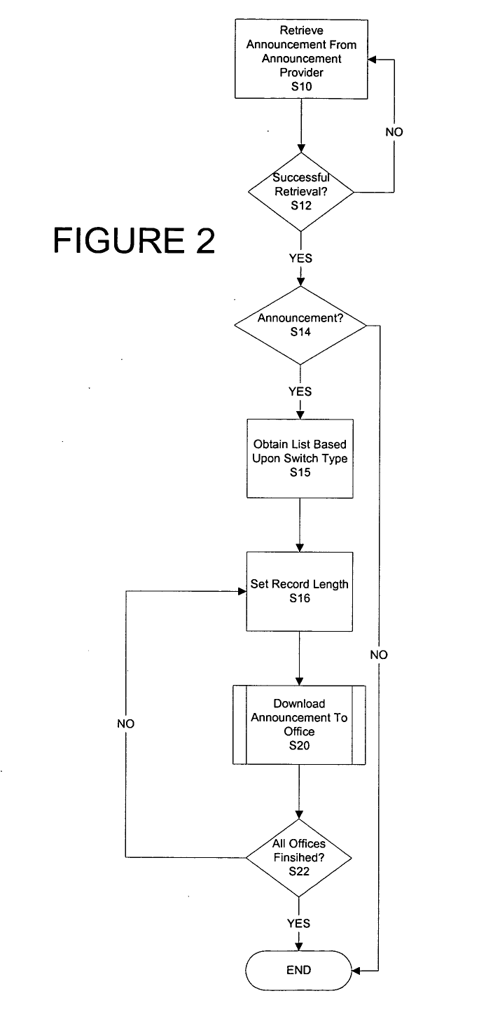

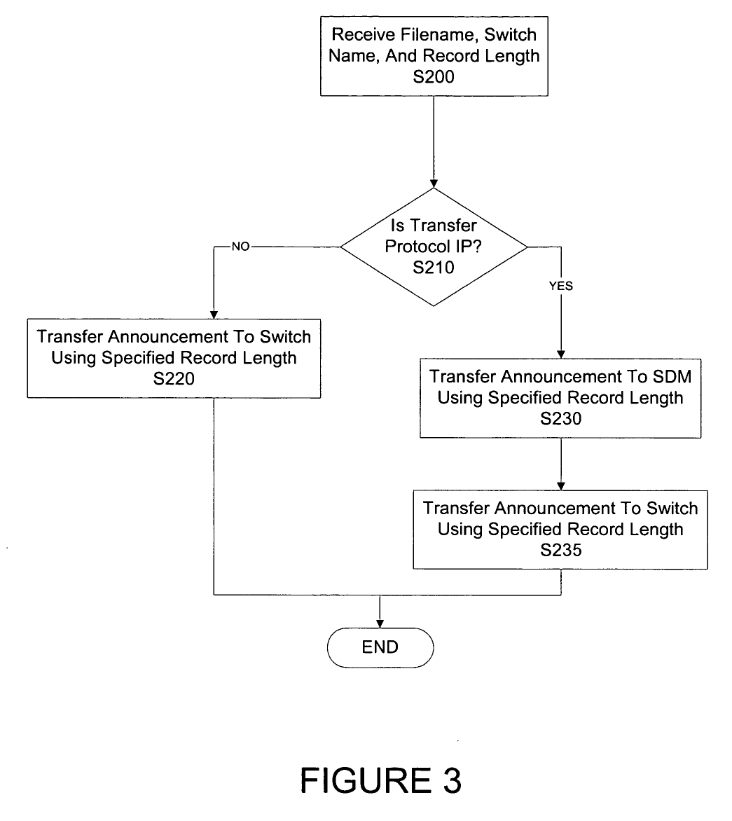

Loading a new custom announcement for a switch 30, 32 is now described with respect to FIGS. 2 and 3. After a new announcement has been created by a announcement provider, the announcement provider stores the announcement in a binary format on the CAN 20. This step differs from the prior art process in which the announcement provider stored the announcement file on tape. The announcement provider then notifies the user of the availability of the announcement file. In response to the notification, a user who intends to load the new announcement launches a software application residing on the CSCANS 10. In one embodiment, the software application includes a master program that downloads the binary file from the CAN 20, and a secondary program that downloads the announcement to the switch 30, 32.

The application requires the announcement name from the user. Based upon the announcement name, the master program downloads the announcement file from the CAN 20 to the CSCANS 10 using FTP, at step S10. At step S12 the master program determines if the download was successful. If so, the logic proceeds to step S14. Otherwise retrieval of the announcement is attempted again.

Because the application started by the user is an application for retrieving announcements, at step S14 the downloaded file is known to be an announcement file. If another similar application downloaded a file (which would not be an announcement) the logic would end (S14: NO). Once the file is decided to be an announcement file, at step S15 the master program obtains a list from the CSCANS 10 of all switches in the region of the CSCANS 10, based upon a specified office type. In this example, all DMS-100s are listed. The process in which a CSCANS 10 generates a list of specified switches types is well known.

Subsequently at step S16, the master program sets the record length for a program that will download the announcement to the switch. The set record length overrides a default record length. In this example, the record length is set to 44 bytes overriding the default record length of 128 bytes. After the record length is set, the secondary program is called at step S20.

FIG. 3 illustrates exemplary logic of the secondary program, which also resides on the CSCANS 10. Initially, at step S200, the program receives parameters from the master program, including the file name of the announcement, the name of the switch to receive the announcement, and the record length. Although a single switch name is described, it is understood that the switch parameter can include multiple switch names, possibly increasing overall processing efficiency.

After receiving the parameters, the secondary program determines the transfer protocol of the specific switch 30, 32 received as the parameter. The determination can occur by comparing the passed in switch name with a table indicating a protocol for each switch name in a region. If the switch 30, 32 is a DMSCOM switch 30 (step S210: YES), at step S220 the secondary program residing on the CSCANS 10 communicates with a program for processing file transfers residing on the switch 30 itself to instruct the program on the switch 30 to expect a binary file with the specified record length. Finally, the announcement is transmitted to the switch 30 using the DMSCOM protocol and the specified record length.

If the switch is not a DMSCOM switch (S210: NO), then the CSCANS 10 communicates with a similar program residing on the SDM 35 to indicate the record length of the binary file being sent, at step S230. The communication is preferably via FTP. Once the SDM 35 receives the binary file, the SDM 35 communicates via FTP to the switch 32 that a binary file having the specified record length will be sent. The switch 32 also includes a program for processing file transfers. Finally, at step S235 the announcement is transferred from the SDM 35 to the switch 32 via FTP.

Returning to FIG. 2, after the secondary program residing on the CSCANS 10 finishes, the master program determines if the secondary program has been called for each switch in the list of switches generated at step S15. If so, the program ends. Otherwise, the process returns to step S16 and repeats with the next switch(es) from the list.

Thus, the present invention enables quick and efficient deployment of custom announcements to switches, such as switches from the Nortel DMS family.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards represent examples of the state of the art. Such standards are periodically superseded by faster or more efficient equivalents having essentially the same functions. Accordingly, replacement standards and protocols having the same functions are considered equivalents.

What is claimed is:

1. A method for deploying a custom announcement to a local exchange switching platform of a telecommunications carrier, the method comprising:
storing on a server a binary file comprising the custom announcement;
electronically providing the binary file to the telecommunications carrier; and
enabling the telecommunications carrier to electronically transfer the binary file to the local exchange switching platform.

2. The method of claim 1, in which the local exchange switching platform comprises a Nortel DMS switch.

3. A method for deploying a custom announcement to a local exchange switching platform of a telecommunications carrier, the method comprising:
electronically receiving, from a server, a binary file comprising the custom announcement;
overriding a default record length with a specific record length;
electronically transferring the binary file, using the specific record length, to the local exchange switching platform.

4. The method of claim 3, in which the local exchange switching platform comprises a Nortel DMS switch.

5. The method of claim 4, further comprising:
determining a protocol of the DMS switch prior to electronically transferring the binary file, using the specific record length, to the DMS switch,
when the protocol comprises DMSCOM, the electronically transferring the binary file using the specific record length further comprises transferring directly to the DMS switch using the DMSCOM protocol; and
when the protocol comprises IP, the electronically transferring the binary file using the specific record length further comprises transferring to the DMS switch via a supernode data manager (SDM) using file transfer protocol (FTP).

6. The method of claim 4, further comprising:
generating a list of DMS switches in a region; and
electronically transferring the binary file, using the specific record length, to each DMS switch in the generated list.

7. A computer readable medium storing a program for deploying a custom announcement to a local exchange switching platform, comprising:
a master code segment that electronically receives a binary announcement file stored on a server and sets a record length; and
a secondary code segment that receives the set record length and electronically transfers the binary announcement file, using the set record length, to the local exchange switching platform.

8. The medium of claim 7, in which the local exchange switching platform comprises a Nortel DMS switch.

9. The medium of claim 8, in which the secondary code segment determines a protocol of the DMS switch prior to electronically transferring the binary file using the specific record length,
when the protocol comprises DMSCOM, the secondary program electronically transfers the binary file, using the specific record length, directly to the DMS switch using the DMSCOM protocol; and
when the protocol comprises IP, the secondary program electronically transfers the binary file, using the specific record length, to the DMS switch via a supernode data manager (SDM) using file transfer protocol (FTP).

10. The medium of claim 8, in which the master program generates a list of DMS switches within a region; and electronically transfers the binary file, using the specific record length, to each DMS switch in the generated list.

11. The medium of claim 8, in which in response to receiving a user-indicated filename of the binary announcement file, the master program electronically receives the binary announcement file from the server of an announcement provider.

12. The medium of claim 8, in which the master program passes parameters to the secondary program, including a filename of the binary announcement file, a name of the DMS switch to receive the binary announcement file, and the specific record length.

13. The medium of claim 9, in which the secondary program communicates the specific record length to a program residing on the SDM, and
the SDM program communicates the specific record length to a program residing on the DMS switch.

14. A system for deploying a custom announcement to a local exchange switching platform of a telecommunications carrier, the system comprising:
a plurality of local exchange switching platforms; and
a first server residing in a region of the telecommunications carrier, the first server electronically receiving a binary announcement file from a second server, and electronically transferring the binary announcement file to at least one of the local exchange switching platforms using a specific record length that overrides a default record length.

15. The system of claim 14, in which the plurality of local exchange switching platforms comprise a plurality of Nortel DMS switches.

16. The system of claim 15, in which at least one of the DMS switches further comprises a supernode data manager (SDM) and an Internet protocol (IP) DMS switch,
wherein the first server determines a protocol of the at least one DMS switch prior to electronically transferring the binary file using the specific record length,
wherein when the protocol comprises DMSCOM, the first server electronically transfers the binary file, using the specific record length, directly to the DMS switch using the DMSCOM protocol; and
wherein when the protocol comprises IP, the first server electronically transfers the binary file, using the specific record length, to the IP DMS switch via the SDM using file transfer protocol (FTP).

17. The system of claim 15, in which the first server generates a list of DMS switches within the region, and electronically transfers the binary file, using the specific record length, to each DMS switch in the generated list.

18. The system of claim 15, in which in response to receiving a user-indicated filename of the binary announcement file, the first server electronically receives the binary announcement file from the server of an announcement provider.

19. The system of claim 16, in which the first server communicates the specific record length to a program residing on the SDM, and
the SDM communicates the specific record length to a program residing on the DMS switch.

20. The system of claim 15, in which the first server comprises a customer services computer access network standard (CSCANS).
